(19) United States
(12) Patent Application Publication
(10) Pub. No.: US 2011/0167344 A1
(43) Pub. Date: Jul. 7, 2011

(54) Media delivery system based on media assets stored in different devices connectable through a communication means

(76) Inventor: Yang Pan, Singapore (SG)

(21) Appl. No.: 12/651,493

(22) Filed: Jan. 4, 2010

(51) Int. Cl. G06F 3/048

(52) U.S. Cl. 715/716; 715/853

(57) ABSTRACT

A media delivery system is disclosed. The system comprises a plurality of devices connectable through a communication network and/or a connector. Media assets may be stored in different devices. Metadata of all the media assets may be stored in each device and is updated whenever it is necessary. A user interface representing media assets available to the user from all connected device at the moment of usages is displayed to the user through an input device.

### CROSS-REFERENCE TO RELATED APPLICATIONS

Not applicable.

### BACKGROUND

1. Field of Invention

This invention relates generally to a media delivery system. More specifically, the invention describes a media delivery system comprising multiple devices connectable through a communication network.

2. Description of Prior Art

A portable media player stores media assets such as songs and video clips, which can be played on the device. Examples of media players are the iPod from Apple Inc. of Cupertino, Calif., the Zen from Creative Technology Ltd, Singapore and the Zune from Microsoft Inc of Redmond, Wash. The portable media players have gained popularity because of its capability to store large number of media assets in a device, which can be put into a user's pocket when one travels.

In order to achieve portability, many portable media players use minimalist displays that allow the user access to the media assets via simple graphical user interfaces. The large number of media assets are organized in a way of automatic hierarchical categorization by metadata as disclosed in a U.S. Pat. No. 6,928,433 to Goodman and Egan (2005). Robbin et al further disclosed a hierarchically ordered graphical user interface in US patent application 2004/0055446. A user, guided progressively by a user interface from the higher order to the lower order, can select a desired media asset.

A media player acquires typically its media assets from a computer with media management applications, such as the iTunes software, which is a product from Apple. In prior art, the portable media players are stored with the media assets transferred from a computer. The management of media database, including selection and purchasing of media assets from an on-line merchant, is performed with the use of the computer connected to the internet.

A user may be accessible to many other electronic devices storing and streaming media assets. In exemplary cases, the media assets may also be stored in a mobile phone comprising a media player, in a set-top box for a media delivery system, in a HiFi system and in a media delivery unit of an automobile. The devices may be connected through a communication network such as the Internet and an ad hoc communication network conforming to standards such as the Bluetooth, the ZigBee and the WiFi. Some of the devices may also be connected through a USB type of connector or through an IEEE 1394 type of connector. The assets stored in the other devices may also be accessible to the user through the high speed communication networks or connectors.

Therefore, it is desirable that a media delivery system comprising multiple devices provides a hierarchical user interface displaying all media assets available to the user at a moment of the usage. The user may access to media assets stored in different devices with the great easiness.

### SUMMARY OF THE INVENTION

It is an objective of the present invention to provide a hierarchical user interface for a media delivery system comprising multiple devices connectable through communication networks and/or wired connectors. The media assets may be stored in different devices. Therefore, the user is able to access media assets stored in all connected devices with the great easiness through the user interface.

The invention described herein pertains to a media delivery system comprising multiple media devices or media servers. The devices are connectable through a communication means. The communication means comprises a communication network such as the Internet, an ad hoc communication network such as one conforming to the Bluetooth (IEEE 802.15.1 and its amendments), the ZigBee (IEEE 802.15.4 and its amendments) and the WiFi (IEEE 802.11 and its amendments) type of standards. The communication means may further comprise a wired connection such as Universal-Serial-Bus (USB) type of connection or an IEEE 1394 type of connection.

Media assets may be stored in different devices such as for example, in a portable media player, in a HiFi system, in a personal computer, in a set-top box for a media delivery system and in an automobile media delivery system. The media assets may also be stored in a media server operated by a merchant. The user may have selected a list of media assets from the server by using bookmarks. Media assets stored in different devices may not be the same ones. A data file including all metadata of the media assets from different devices may be stored in each device. The data file is updated and synchronized when each time a new device is connected or when an existing device is removed from the network.

When a user selects a specific device such as a portable media player for playing a media asset, the device checks the other devices being connected to the selected device. The list of available media assets is determined subsequently. The user interface displays the media categories of all available media assets in a hierarchical manner. If the user selects a media asset that is not stored locally, the media asset is then transferred from the storing device to the selected device through the communication means. The selected device is also called operating device through this disclosure. If the user selects a media asset that the user does not own, a message that requests the user to purchase the asset is then displayed on a screen of the operating device.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram illustrating an exemplary media delivery system;

FIG. 2 is a schematic diagram illustrating different media devices and media servers are connected either through a communication network or through wired connections;

FIG. 3 is a diagram of a file format for storing filed data and file attributes with an added field indicating the devices that the asset is stored;

FIG. 4 is a user's view of hierarchy of the user interface with the assets that user does not own being marked;

FIG. 5 is a schematic representation of an exemplary illustration of the hierarchical user interface of a portable media player;

FIG. 6 is a flowchart illustrating the operation of the media delivery system;

FIG. 7 is a flowchart illustrating a process that the user interface is updated after the devices are connected to the operating device.

FIG. 8 is a flowchart illustrating the user interface is updated when the status of device connection is changed, i.e. an existing device is removed or a new device is added.

FIG. 9 is a flowchart illustrating the selected asset is transferred from the connected device to the operating device.

### DETAILED DESCRIPTION

References will now be made in detail to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

The present disclosure uses a portable media player as an exemplary case to illustrate the inventive concept. A plurality of media devices such as a personal computer, a set-top box for a digital television, a HiFi system, an automobile media delivery system and a media server may be connected to the media player through a communication means. The communication means may comprise the Internet, ad hoc communication networks and wired connections.

The media player typically has connection capabilities that allow a user to upload and download data to and from a host device such as a general purpose computer. With regard to music player, songs and playlists stored on the general purpose computer may be downloaded into the music player. In our description of the invention, a music player is taken as an exemplary case for the purpose of the illustration but not limit the scope of the invention.

The basic operation of a media player (music player) is described as follows. A portable media player comprises a processor and a file storage system that is typically a flash memory or a plurality of flash memories. It further comprises user interface unit such as a Liquid Crystal Display (LCD) screen and a user input device such as a rotational user input device used in an iPod from Apple. The file system stores media assets. A user selects a media asset from the user interface. The processor receives the selection and controls the operation of sending the selected media asset to coder/decoder (CODEC) for the signal processing to generate analog signal for further delivering to speakers for an audio experience in case of a music player. The media player has a data link for connecting to a computer. A battery, more particularly, a rechargeable battery is used to provide power for the player.

The media player includes a user input device that allows a user to interact with the device. For example, the user input device can take a variety of forms, such as a button, keypad, dial, etc. A rotational user interface as implemented by Apple in iPod has gained significant popularity. The rotational input device can be continuously actuated by a circular motion of the finger. The finger may rotate relative to an imaginary axis. In particularly, the finger can be rotated through 360 degree of rotation without stopping. This form of motion may produce continuous or incremental scrolling through the list of songs being displayed on the display screen.

Since the display screen associated with a handheld media player is typically small, an efficient user interface is required to allow a user intuitively navigate among, and select, songs to be played. The operation typically includes an overlapping hierarchy of categories. Categories include items that can also be included in other categories so that the categories overlap with each other. Thus, a song title can be accessed in multiple different ways by starting with different categories. For example, the top-level categories “Album”, “Artists”, “Genres” and “Playlists” are presented to a user first. Within the Albums category are names of different albums of songs stored in the device. Within each album are album tracks, or songs, associated with that album. Similarly, the Artists category includes names of artists which are, in turn, associated with their albums and songs. The Genre category includes types of categories of music such as “Rock”, “Classical”, “Pop”, etc. Within these sub-categories are found associated songs. Finally, the “Playlists” category includes collections of albums and/or songs which are typically defined by the user.

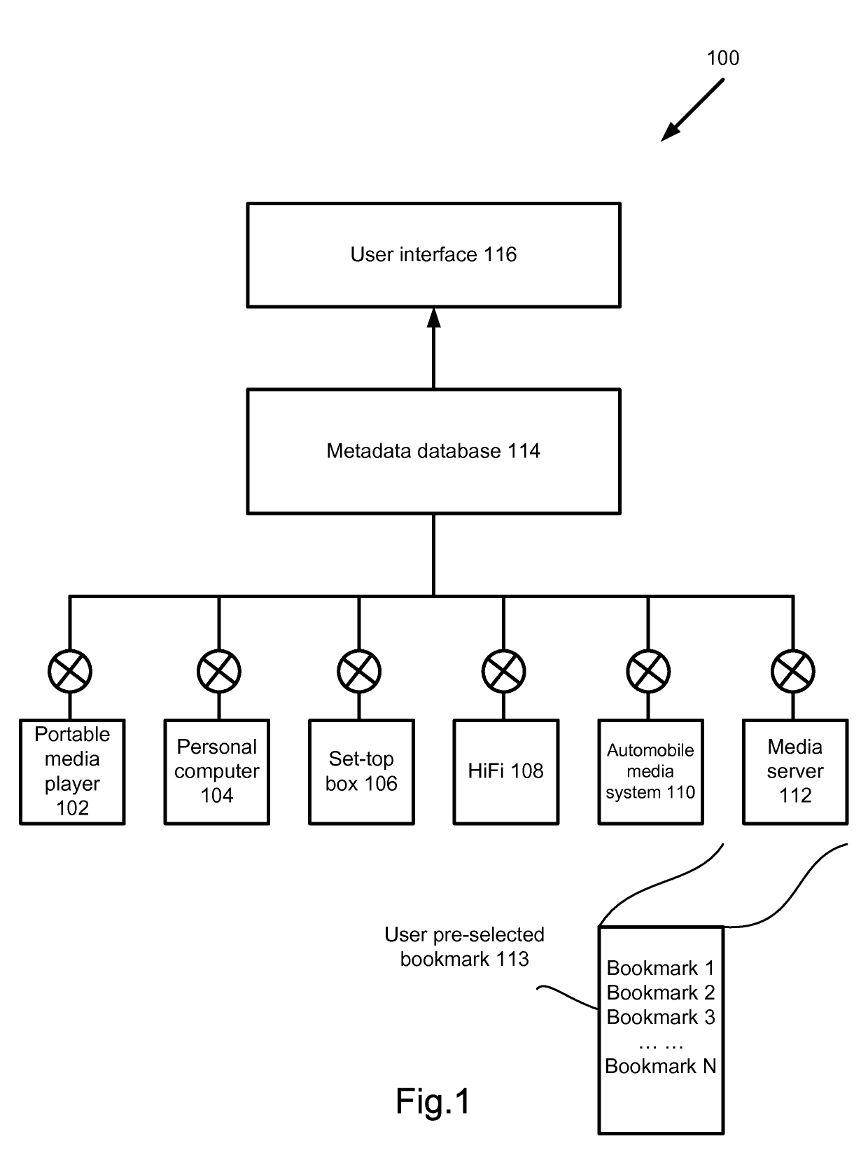

FIG. 1 is a schematic diagram illustrating an exemplary media delivery system 100 comprising a portable media player 102, a personal computer 104, a set-top box 106, a HiFi system 108, an automobile media system 110 and a media server 112. The devices are connectable through a communication means. A media asset may be stored in one or more devices. The media assets stored in the media server 112 may not be owned by the user. The user may have a list of pre-selected media assets represented by a list of bookmarks 113. A metadata database 114 includes a list of metadata of all media assets stored in 102 to 11. 114 may further include the bookmarks from 112. A user interface 116 based on the metadata database 114 delivers a hierarchical way of displaying metadata of media assets. The metadata 114 may be stored in every device in the media delivery system. It is desirable that devices in the system use similar way of displaying the user interface. A rotational user input device for the portable media player has recently gained significant popularity. A similar user input device may be implemented as a remote control device for the set-top box 106, the HiFi system 108 and the automobile media system 110. The other popular method of displaying the user interface may include a hierarchical way of display based on a touch-screen type of display/input device.

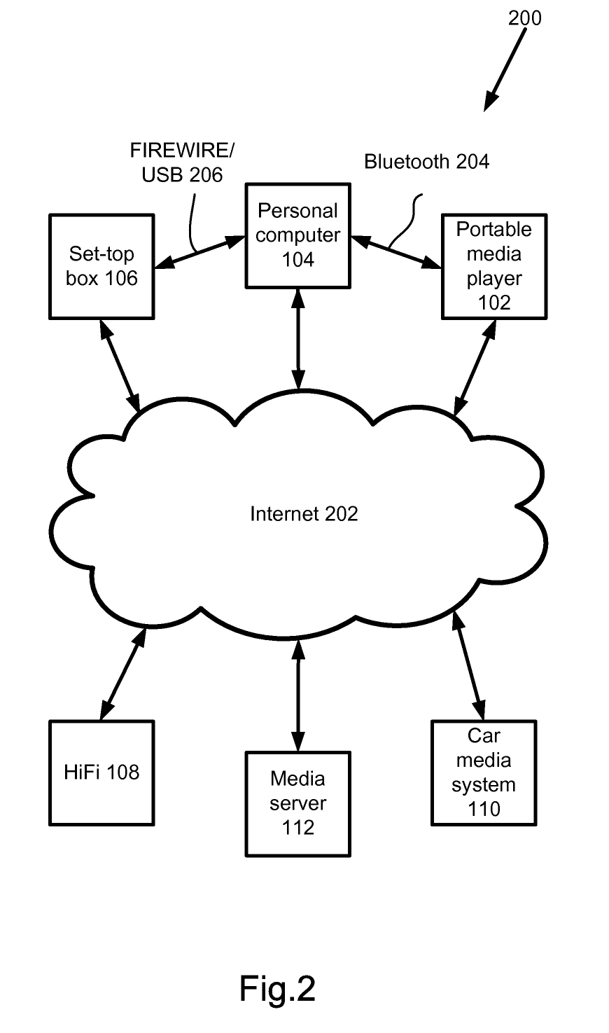

FIG. 2 is a schematic diagram illustrating media devices 102-110 and the media server 112 are connected either through the Internet 202 or through an ad hoc connection 204 using the Bluetooth (IEEE 802.15.1 and its amendments) or through a wired connection 206 using FIREWIRE (IEEE 1394)/USB. Anyone of the media device of the system 200 may be able to access media assets stored in any other device when connected. It should be noted that the other ad hoc communication links such as for example, the ZigBee (IEEE 802.15.4 and its amendments) and the WiFi (IEEE 802.11 and its amendments) may also be employed for connecting the devices or for connecting the devices to the Internet.

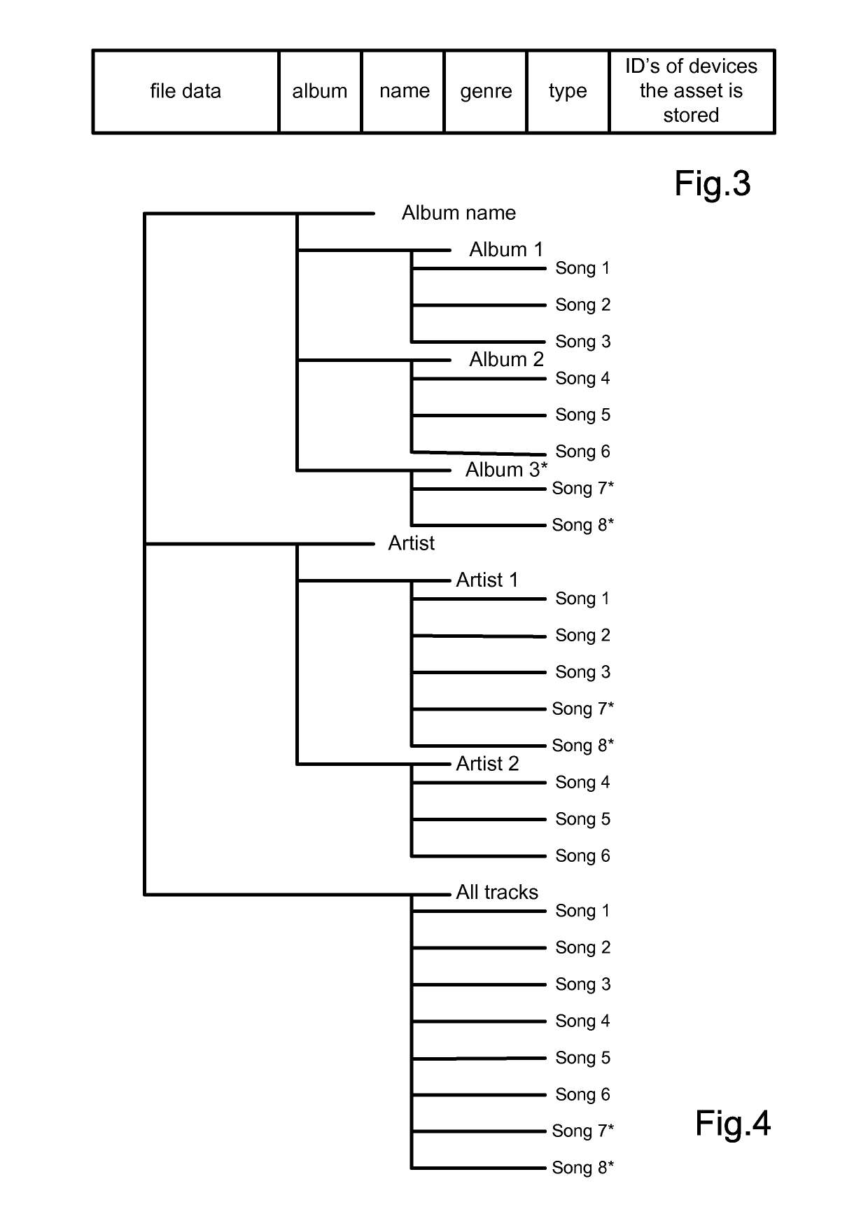

FIG. 3 is a schematic diagram of a file format for storing filed data and file attributes with an added field indicating the devices that the asset is stored. A data file including all metadata of media assets is stored in every device in the media delivery system 100. When a device is accessed by a user to select and to play a media asset, the other devices being connected can be identified. From the added field indicating the device that the asset is stored, all media assets available to the users from all connected devices can be determined immediately. It should be noted that it may be necessary that the metadata databases 114 stored in different devices are synchronized after the devices are connected. The synchronization may also be carried out in background when none of the device is used by the user. The data file may be updated immediately when one of the connected devices is removed or when a new device is added to the network.

FIG. 4 is a user's view of hierarchy of the user interface with the assets that user does not own being marked. The marked assets may be bookmarks of the preselected assets by the user from the media server 112. In the exemplary case as illustrated in FIG. 4, the user interface may include both the assets already own by the user and the assets not own by the user. Furthermore, anyone of the assets may be stored locally or stored in other devices in the media delivery system 100. When the user selects an asset not own by him or her, a purchasing process must be completed before the asset is played. The methods for purchasing the asset are well known in the prior arts.

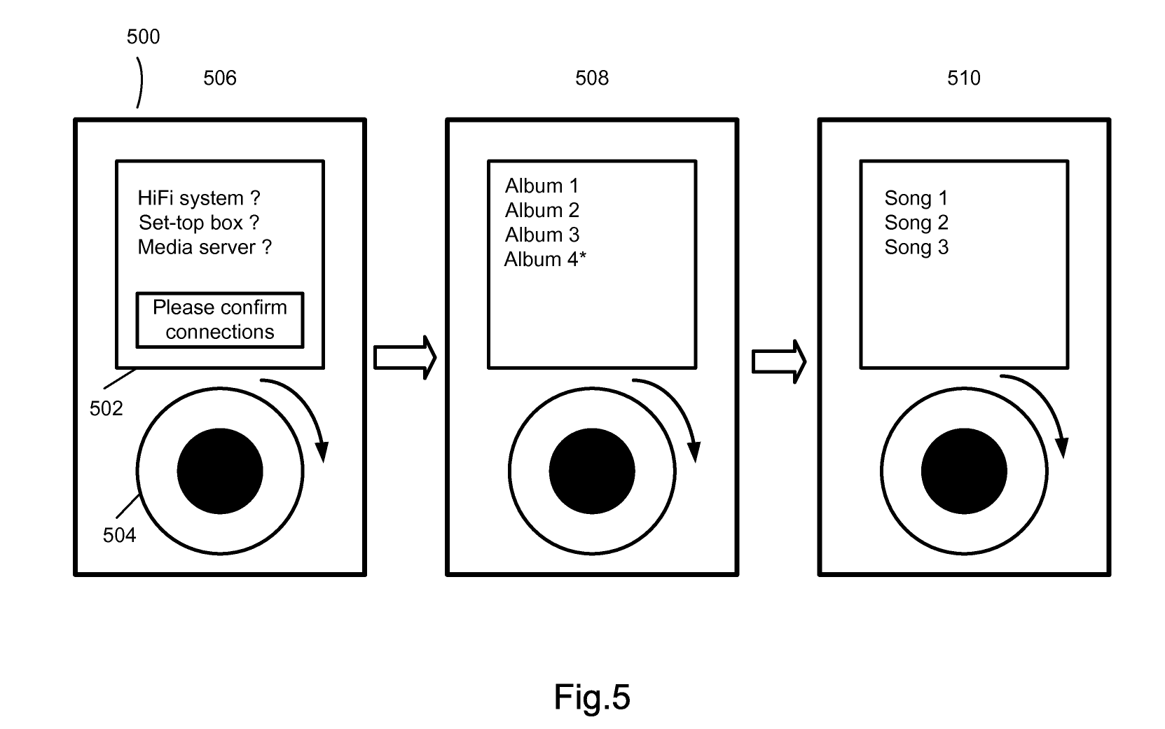

FIG. 5 is a schematic representation of an exemplary illustration of the hierarchical user interface of a portable media player 500. The portable media player 500 comprises a display 502 and a rotational user interface 504. 506 illustrates that the media player 500 displays a list of devices being connected. The user is asked to confirm each of the connections. After the confirmation, 508 illustrates that the first level of the hierarchical user interface is displayed with the album not own by the user being marked. 510 illustrates a second level of the hierarchical user interface with each asset in the selected album is displayed for a further selection from the user.

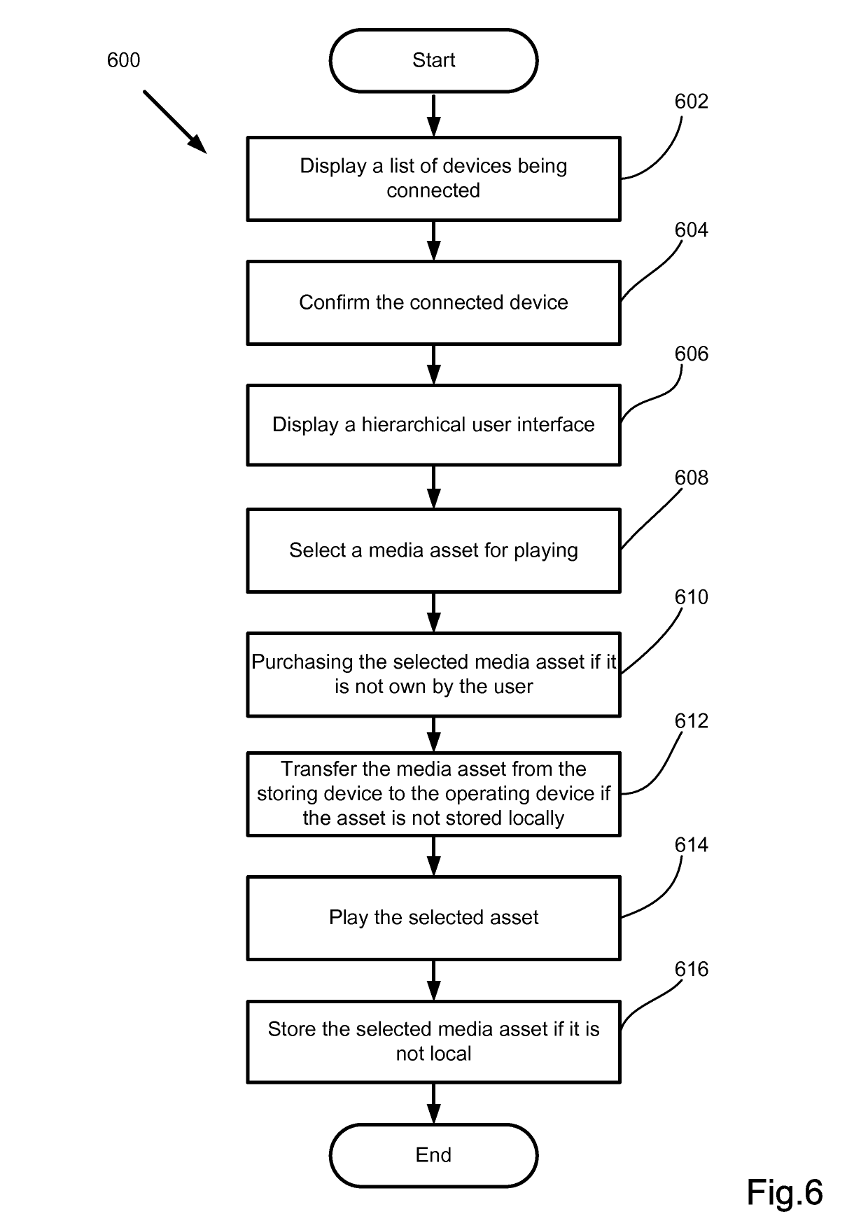

FIG. 6 is a flowchart illustrating the operation of the media delivery system. Process 600 starts with step 602 that a list of devices being connected is displayed. The connection of each device is confirmed by the user in step 604. After the data file for the metadata is updated, a hierarchical user interface is displayed in step 606. A media asset is selected by the user in step 608. The selected media asset is purchased in step 610 if the selected asset is a bookmark representing an asset from the media server 112. The media asset is subsequently transferred from the device it is stored to the operating device in step 612 if the asset is not stored locally in the operating device. The selected asset is played in step 614. The transferred asset may be stored in step 616. The data file for metadata is then updated accordingly.

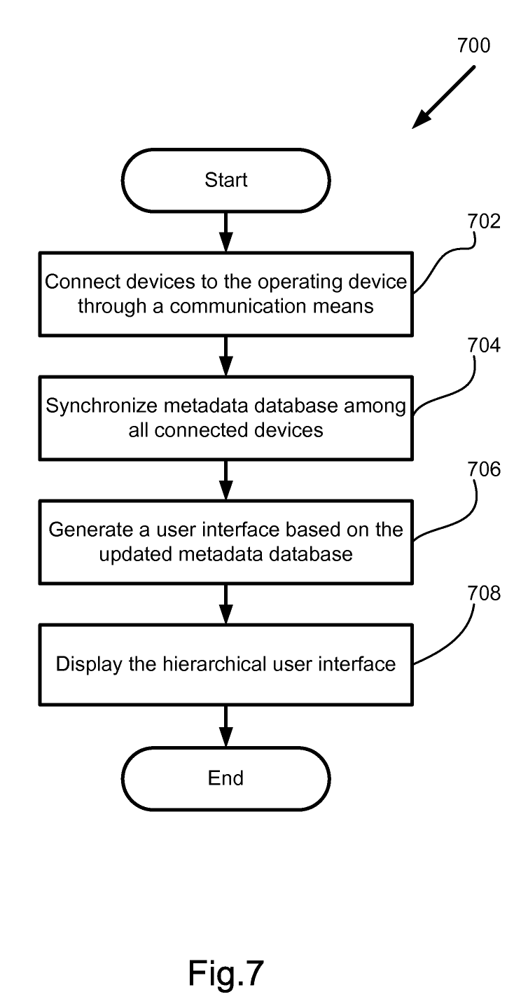

FIG. 7 is a flowchart illustrating a process 700 that the user interface is updated after the devices are connected to the operating device. Process 700 starts with step 702 that devices are connected to the operating device through the communication means as illustrated exemplarily in FIG. 2. The data file for metadata of all available media assets of all connected devices is updated and synchronized in step 704. The user interface is generated in step 706 accordingly. The hierarchical user interface is then displayed in step 708.

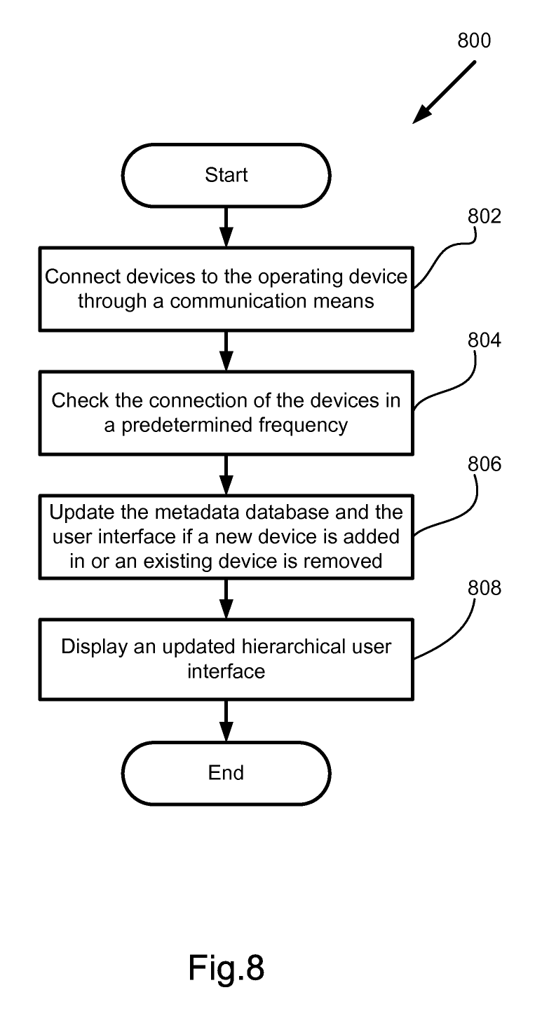

FIG. 8 is a flowchart illustrating the user interface is updated when the status of device connection is changed, i.e. device is removed or the new device is added. Process 800 starts with step 802 that devices are connected to the operating device through the communication means as shown exemplarily in FIG. 2. The connection of each device is checked in a predetermined frequency in step 804. The data file for metadata of all available media assets is updated in step 806 when each time a device is removed from the network or when a new device is added to the network. The updated user interface is displayed in step 808.

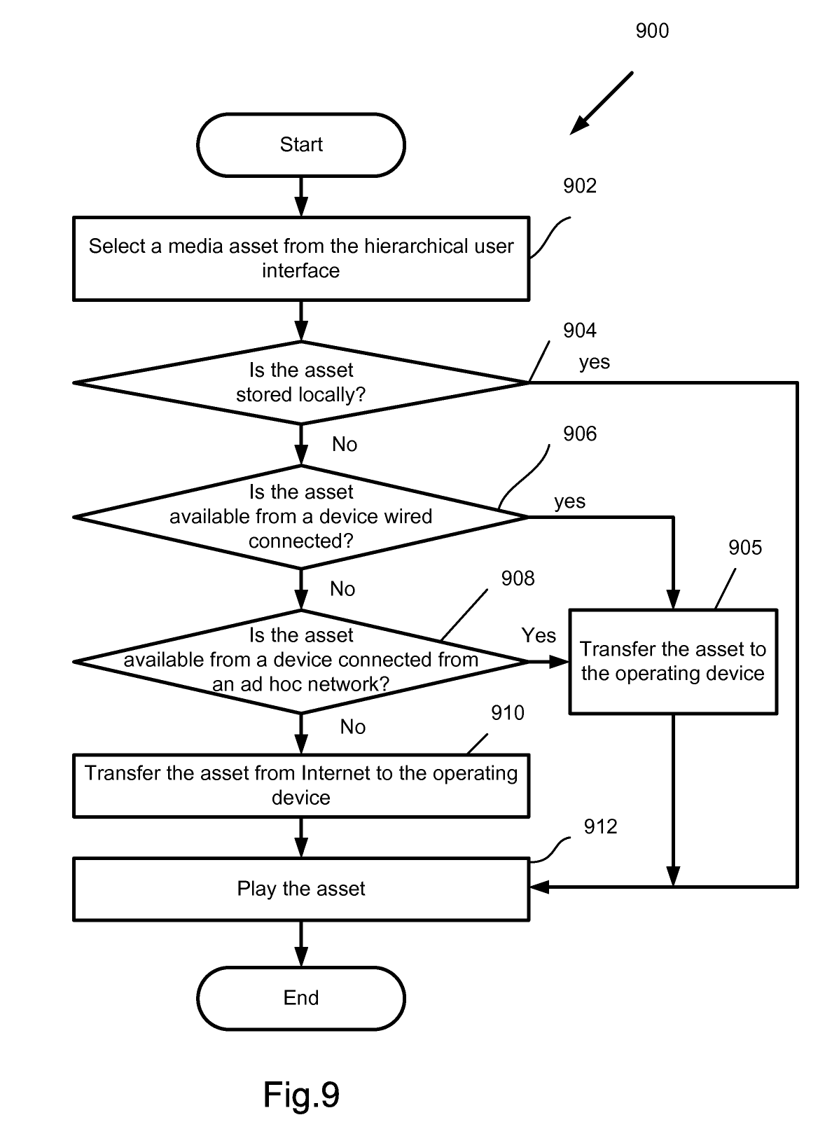

FIG. 9 is a flowchart illustrating the selected asset is transferred from the connected device to the operating device. Process 900 starts with step 902 that a media asset is selected from a hierarchical user interface. In step 904, it is checked if the selected asset is available locally from the operating device. If the asset is not available locally, it is checked in step 906 if the asset can be found from the devices connected in a wired manner to the operating device. Further, if the asset still cannot be found, it is checked if the asset can be found from the devices connected through the ad hoc communication means in step 908. If the asset can be found locally in step 904, the asset is played in step 912. If the asset can be found from the device either wired connected or connected through the ad hoc means, the asset is transferred to the operating device is step 905 before it is played in step 912. The asset may also be transferred from a device connected through the Internet in step 910 and is played in step 912.

The asset may be stored in more than one devices, the process 900 ensures that the asset is selected and transferred from the easiest path of communication network.

1. A media delivery system comprising:
a. a plurality of devices connectable through a communication means;
b. a plurality of media assets stored in the devices; and
c. a hierarchical user interface for all available media assets from the devices being connected.

2. The system as recited in claim 1, wherein said devices including one or more devices from the following group:
a. a portable media player;
b. a personal computer;
c. a HiFi audio system;
d. a set-top box;
e. an automobile media delivery system; and
f. a media server.

3. The system as recited in claim 1, wherein said devices comprising at least one device including a plurality of media assets not own by the user, wherein a subset of the assets may have been selected by the user using bookmarks that are available to the user through the hierarchical user interface.

4. The system as recited in claim 1, wherein said media assets including:
a. an audio file;
b. a video file;
c. an image;
d. a game;
e. a text file; and
f. a multimedia file.

5. The system as recited in claim 1, wherein said communication means further including:
a. the Internet;
b. an ad hoc communication network conforming to one or a combination of standards including: IEEE 802.11; IEEE 802.15.1, IEEE 802.15.4 and their amendments;
c. a Universal-Serial-Bus (USB) type of connector; and
d. an IEEE 1394 type of connector.

6. The system as recited in claim 1, wherein said each device including a data file comprising a list of metadata of all available media assets, wherein said data file may be updated when each time the connection of devices is altered.

7. The system as recited in claim 6, wherein said metadata including a data structure comprising a field indicating the device (s) the media asset is stored.

8. The system as recited in claim 1, wherein said user interface including the metadata of the assets own by the user and that of the assets not own by the user, wherein the difference is indicated by a visible symbol when the user interface is displayed, wherein the user may decide to purchase an asset before the asset is played.

9. The system as recited in claim 1, wherein said system further comprising a means of transferring the selected media asset from a connected device to the operating device for playing by employing said communication means.

10. A method of selecting a media asset by a user from a plurality of media assets stored in a plurality of devices connectable through a communication means, the method comprising:
a. selecting one device for playing a media asset;
b. determining devices being connected to the selected device;
c. determining media assets available to the user in the selected device and in the devices being connected; and
d. displaying a hierarchical user interface for the available media assets.

11. The method as recited in claim 10, wherein said devices including one or more devices from the following group:
a. a portable media player;
b. a personal computer;
c. a HiFi audio system;
d. a set-top box;
e. an automobile media delivery system; and
f. a media server.

12. The method as recited in claim 10, wherein said devices comprising at least one device including a plurality of media assets not own by the user, wherein a subset of the assets may have been selected by the user using bookmarks that are available to the user through the hierarchical user interface.

13. The method as recited in claim 10, wherein said media assets including:
a. an audio file;
b. a video file;
c. an image;
d. a game;
e. a text file; and
f. a multimedia file.

14. The method as recited in claim 10, wherein said communication means further including:
a. the Internet;
b. an ad hoc communication network conforming to one of or a combination of the following standards: IEEE 802.11; IEEE 802.15.1; IEEE 802.15.4 and their amendments;
c. a Universal-Serial-Bus (USB) type of connector; and
d. an IEEE 1394 type of connector.

15. The method as recited in claim 10, wherein said each device including a data file comprising a list of metadata of all available media assets, wherein said data file may be updated when each time the connection of the devices is altered.

16. The method as recited in claim 15, wherein said metadata of the media asset including a data structure comprising a field indicating the device (s) that the media asset is stored.

17. The method as recited in claim 10, wherein said user interface including the metadata of the assets own by the user and that of the assets not own by the user, wherein the difference is indicated by a visible symbol when the user interface is displayed, wherein the user may decide to purchase the asset not own before the asset is played.

18. The method as recited in claim 10, wherein the method further comprising a step of transferring the selected media asset from a connected device to the selected device by employing said communication means.

19. A hierarchical user interface for a portable media player comprising:
a. a data file including a list of metadata of media assets stored in the portable media player; and a list of metadata of media assets stored in one or a plurality of devices connected to the media player through a communication means; and
b. a hierarchical structure for displaying the metadata.

20. The user interface as recited in claim 19, wherein said communication means further including:
a. the Internet;
b. an ad hoc communication network conforming to one or a combination of the following standards including: IEEE 802.11; IEEE 802.15.1; IEEE 802.15.4 and their amendments;
c. a Universal-Serial-Bus (USB) type of connector; and
d. an IEEE 1394 type of connector.
